(19) United States
(12) Patent Application Publication
(10) Pub. No.: US 2010/0103851 A1
(43) Pub. Date: Apr. 29, 2010

(54) SYSTEM FOR ENABLING COMMUNICATION OVER A WIRELESS INTERMITTENTLY CONNECTED NETWORK

(75) Inventors: Suresh Kumar Chintada, Karnataka (IN); Seshadri R, Bangalore (IN); Shrikant S. Naidu, Bangalore (IN); Moushumi Sen, Bangalore (IN)

Correspondence Address: MOTOROLA, INC, 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/257,387

(22) Filed: Oct. 23, 2008

(51) Int. Cl. H04H 20/71; H04W 4/00; G06F 15/173

(52) U.S. Cl. 370/312; 370/338; 709/225

(57) ABSTRACT

Disclosed are methods, apparatus' and systems for enabling communication over wireless intermittently connected networks. A system includes at least one dispatch center for managing various communications of the intermittently connected network, a plurality of geographically separated nodes and a plurality of mobile terminals. The at least one mobile terminal is configured to provide a communication network to the plurality of geographically separated nodes for the transfer of information among the plurality of geographically separated nodes. The information is at least in part based upon the various communications managed and communicated to at least one mobile terminal by the at least one dispatch center, and comprises one or more of authentication parameters, security credentials, provisioning parameters, routing information, connection setup messages, services, messages, and diagnostics. Authentication between entities is completed, and in turn, provisioning is completed and capabilities and services are established prior to messaging commencing.

### FIELD OF THE DISCLOSURE

The present disclosure relates generally to the communication of messages within a wireless intermittently connected network.

### BACKGROUND

In some geographical locations, such as rural regions, and some developing countries, there may be a deficiency of linked, reliable, physical infrastructure to provide Internet-based communications. Internet-based communications, for example, include electronic messaging, web-based researching, and the like. While the Internet is available via satellite nearly anywhere on the globe, such services are cost prohibitive to most rural end users. Therefore, it is desirable to provide alternative low-cost Internet-based communication services to locations lacking reliable physical infrastructure.

One system for bringing Internet-based communication to locations lacking reliable physical infrastructure is an intermittently connected network. An intermittently connected network provides communication via a disconnected or a delay tolerant network architecture, thereby providing, for example, asynchronous communication services to remote locations that have no basic communication facilities. An intermittently connected network functions in accordance with two fundamental premises. Firstly, communications need not be real-time synchronous communications and secondly, that wireless cellular coverage with data (for example: General Packet Radio Service (GPRS), Enhanced Data rates for Global System for Mobile communications (GSM) Evolution (EDGE), 1X,3G) is available in geographical pockets (example: spanning major highways). Limited coverage can be provided, for example, by a cellular network with the help of a data mule on a physical transport and Wireless Fidelity (WIFI) (802.11b/g) connectivity to the subscribers of the network residing in non-coverage areas such as rural areas of high growth markets. (Note: for any IEEE standards recited herein, see: http://standards.ieee.org/getieee802/index.html or contact the IEEE at IEEE, 445 Hoes Lane, PO Box 1331, Piscataway, N.J. 08855-1331, USA.)

Asynchronous network capabilities leverage existing infrastructure elements, thus exchanging coverage for real-time communications. Such an architecture enables the rural subscribers to send and receive multimedia messages. Illustrative examples which can benefit from the use of such a network include the communication of voice, still picture, and/or video messages, Internet portal transactions such as business and government Internet-based services, and the like.

In one implementation, an intermittently connected network supports multimedia communication applications for enabling end users to communicate using shared (kiosk) or personal communication devices (handset). Such a system can enable services that can support asynchronous applications using store and forward mechanisms to provide a reliable communication infrastructure with guarantees of service. Services and applications within such a network are provisioned by the network operator and made available to subscribers. Multimedia messaging is one such service that enables end users to communicate. Other services, for example, include roaming between systems, file transfers, government-to-citizen interactions, cached web systems, and interfacing to Cellular messaging systems such as Short Message Service (SMS)/Multimedia Messaging Service (MMS).

The sporadic nature of connectivity characterizes a disconnected network. The difference in the computing power of the various geographically separated elements of the network also may substantial. Moreover, the various devices operating within the network may be very different. Constraints on the bandwidth, processing power and storage capabilities of components of intermittently connected networks can make routine Internet-based communications slow and unreliable.

Therefore, what is needed is a system for enabling communication over a wireless intermittently connected network which overcomes some of the challenges described herein.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a system for enabling communication over a wireless intermittently connected network in accordance with some embodiments.

FIG. 2 is a block diagram of a system for enabling communication over a wireless intermittently connected network in accordance with some embodiments.

FIG. 3 is a block diagram of a system for enabling communication over a wireless intermittently connected network in accordance with some embodiments.

FIG. 4 is a block diagram of a system for enabling communication over a wireless intermittently connected network in accordance with some embodiments.

FIG. 5 is an example flowchart of a process by which a mobile terminal of the system controls the messages for the transfer of information to a geographically separated node in accordance with some embodiments.

FIG. 6 is a chart of examples of various provisioning parameters in accordance with example system elements in accordance with some embodiments.

FIG. 7 illustrates an example outgoing call flow for messaging from a geographically separated node in accordance with some embodiments.

FIG. 8 illustrates examples of different states of a mobile terminal in accordance with some embodiments.

FIG. 9 illustrates an example transition state table in accordance with some embodiments.

FIG. 10 illustrates an embodiment of different states for different data connections in the disclosed system and is independent of the actual type of physical access media used in accordance with some embodiments.

FIG. 11 illustrates an example transition state table in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Disclosed are methods, apparatus' and systems for enabling communication over wireless intermittently connected networks. A system includes at least one dispatch center for managing various communications of the intermittently connected network, a plurality of geographically separated nodes and a plurality of mobile terminals.

The “Dispatch Center” refers to a system within the cellular network infrastructure that provides the dispatch functionality in the intermittently connected network system by facilitating storage and forwarding of information received from anywhere to appropriate geographically separated nodes destinations in the intermittently connected network via one or more mobile terminals.

The “plurality of geographically separated nodes” refers to a part of the system which may be privately or publicly owned stand-alone user-interface machines, such as Kiosks, booths, terminals, and the like, with WIFI connectivity and optionally, mobile handsets owned, leased, operated or shared by individuals. For example, one or more geographically separated nodes may be physically located in a village of a rural locale. The geographically separated node can be managed by a local entrepreneur who, for example, would help subscribers to register for services as well as access registered services for a small price. One of a plurality of geographically separated nodes refers to a client device that forms the end node in the intermittently connected network system which uses opportunistic connections to mobile terminal devices for accessing applications and services. A geographically separated node, in one application, acts as a local mail exchange server for a given set of subscribers usually belonging to a single village or a community. The subscribers are provisioned in the geographically separated node and provided individual subscriber identities, storages space, and the like. The geographically separated node is a trusted entity within the intermittently connected network system domain.

One of a plurality of mobile terminals refers to a device that physically carries the communication service in the intermittently connected network system. The plurality of mobile terminals may be dual-mode (with Cellular and WIFI connectivity) riding on a physical mobile transport network. A mobile terminal device could be hand-carried or hooked onto a physical transport system like a bus or a motorbike, bicycle, and the like. A mobile terminal device stores and carries information and transfers the information to geographically separated nodes, to other mobile terminals or to the dispatch center. A mobile terminal device enables a store and forward information transfer conduit within the intermittently connected network system.

In one embodiment, the disclosed system controls message flows between at least one dispatch center and at least one mobile terminal. In another embodiment, the plurality of mobile terminals are configured to communicate messages with each other, and to provide a communication network to the plurality of geographically separated nodes for the transfer of information among the plurality of geographically separated nodes. In another embodiment, at least one mobile terminal is intermittently communicatively coupled to one or more of the plurality of geographically separated nodes. The at least one mobile terminal is configured to provide a communication network to the plurality of geographically separated nodes for the transfer of information among the plurality of geographically separated nodes. The information is at least in part based upon the various communications managed and communicated to at least one mobile terminal by the at least one dispatch center, and comprises one or more of authentication parameters, security credentials, provisioning parameters, routing information, connection setup messages, services, messages, and diagnostics. Authentication between entities is completed, and in turn, provisioning is completed and capabilities and services are established prior to messaging commencing.

Since constraints on the bandwidth, processing power and storage capabilities of the components of intermittently connected networks can make routine Internet-based communications slow and unreliable, systems for controlling message flows that minimize the effects of the mentioned constraints are desirable. The system of the present invention controls the messages for the transfer of information so that Internet-based communications have more reliability in the discussed intermittently connected network.

As intermittently connected networks become more prevalent, bringing low-cost Internet-based communication services to otherwise unconnected regions such as rural areas, systems for enabling communication over a wireless intermittently connected network which are independent of the services and/or applications are highly beneficial. Moreover, it would be beneficial if the above-discussed constraints were minimized by controlling message flows in a manner that facilitates deployment of services and/or applications.

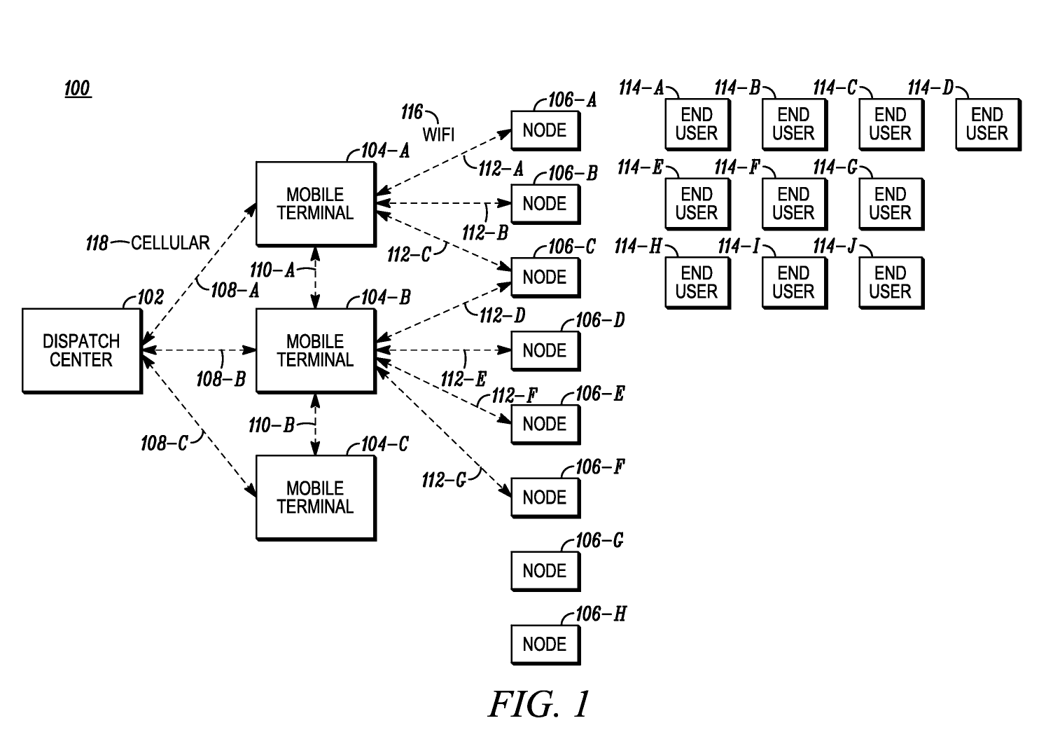

FIG. 1 is a block diagram of a system for enabling communication over a wireless intermittently connected network 100 in accordance with some embodiments. The system controls message flows between a dispatch center 102, a plurality of mobile terminals 104-A, 104-B and 104-C and a plurality of geographically separated nodes 106-A, 106-B, 106-C, 106-D, 106-E, 106-F, 106-G and 106-H. While FIG. 1 and following figures depict a particular number of dispatch centers, mobile terminals, geographically separated nodes, and users, it is understood that their numbers are for illustrative purposes and any quantity of each can be implemented within the scope of the present invention. Various communications (also referred to as “message flows”) in FIG. 1 are depicted by dotted lines. Between the dispatch center 102 and the mobile terminals 104-A, 104-B and 104-C, a plurality of messages 108-A, 108-B and 108-C can be communicated. Messages 110-A and 110B, for example, can be communicated between the mobile terminals 104-A, 104-B and 104-C. Messages 112-A, 112-B, 112-C, 112-D, 112-E, 112-F and 112-G similarly can be communicated between the mobile terminals 104-A, 104-B and 104-C and the geographically separated nodes 106-A, 106-B, 106-C, 106-D, 106-E, 106-F, 106-G and 106-H. One or more end users, such as end users 114-A, 114-B, 114-C, 114-D, 114-E, 114-F, 114-G, 114-H, 114-I and 114-J can utilize the geographical separated nodes 106-A, 106-B, 106-C, 106-D, 106-E, 106-F, 106-G and 106-H. The architecture of the network of FIG. 1 provides access for the various end users 114-A, 114-B, 114-C, 114-D, 114-E, 114-F, 114-G, 114-H, 114-I and 114-J to Internet-based applications and services which otherwise may not be readily available.

At least one dispatch center 102 is configured to manage various communications of the intermittently connected network 100. The primary function of the dispatch center 102 is dispatching services. The dispatch center 102 is part of a fixed infrastructure communication network, such as a cellular network, and is presumed to be reliably connected to the Internet. The fixed infrastructure network, for example, can be a network utilizing packet data protocols such as OFDMA (orthogonal frequency division multiple access), TDMA (time division multiple access), GPRS (General Packet Radio Service) and EGPRS (Enhanced GPRS). The fixed infrastructure network, alternatively, can utilize a code division multiple access (CDMA) or other analog or digital cellular communication system protocols such as, but not limited to, the Global System for Mobile Communications (GSM) protocol.

The dispatch center 102 can be composed of a single physical machine in the fixed network, or it can be a network of machines serving a complex and vast asynchronous network. The dispatch center 102 uses the fixed infrastructure network for communicating with the mobile terminals 104-A, 104-B and 104-C when the mobile terminals 104-A, 104-B and 104-C roam into and are communicatively connected to the fixed infrastructure network. The proximity of a mobile terminal 104-A, 104-B and 104-C is detected in the fixed infrastructure network, and a connection between the mobile terminal 104-A, 104-B and 104-C and a dispatch center 102 is established. Messaging between the dispatch center 102 and the mobile terminals 104-A, 104-B and 104-C is described in detail below.

As discussed, the dispatch center 102 provides dispatch functionality. In addition to dispatching services, the dispatch center 102 is responsible for, among other things, receiving, storing and distributing data from different mobile terminals 104-A, 104-B and 104-C. By facilitating storage and forwarding of information to the destination geographically separate nodes 106-A, 106-B, 106-C, 106-D, 106-E, 106-F, 106-G and 106-H via one or more mobile terminals 104-A, 104-B and 104-C or via the Internet, the dispatch center 102 also serves as an Internet gateway for users 114-A, 114-B, 114-C, 114-D, 114-E, 114-F, 114-G, 114-H, 114-I and 114-J by routing messages, queries and information between the intermittently connected network 100 and the Internet. Apart from this primary function, it is also responsible for provisioning of geographically separated nodes 106-A, 106-B, 106-C, 106-D, 106-E, 106-F, 106-G and 106-H and mobile terminals 104-A, 104-B and 104-C in the system 100 and authentication of the mobile terminals 104-A, 104-B and 104-C. The dispatch center 102 also serves as a billing and services portal for geographically separated nodes 106-A, 106-B, 106-C, 106-D, 106-E, 106-F, 106-G and 106-H and mobile terminals 104-A, 104-B and 104-C operators. It will be appreciated by those of ordinary skill in the art that the difference in the computing power of a dispatch center 102, a mobile terminal 104-A and a geographically separated node 106-A, may substantial. Moreover, different mobile terminals as well as different geographically separated nodes can be of substantially different types of machines.

A geographically separated node, such as geographically separated node 106-A (hereinafter in the singular referred to as geographically separated node 106-A) is a shared device which has, for example, WIFI 116 capability and is used primarily for private and secure access to a user's (hereinafter in the singular referred to as user 114-A) communication services including, composing, sending, receiving and consuming multimedia messages. A geographically separated node 106-A is typically run by an operator who would help users 114-A that are subscribers to register for services as well as access registered services for a small fee. The user interface design of a geographically separated node 106-A takes into account localization needs to cater to people with varying levels of literacy and built upon existing paradigms of communication to improve usability. A registered user 114-A on a geographically separated node 106-A typically needs to provide a login name and a password to access his communication services. Optionally, there is also a provision to support biometric based authentication system.

The geographically separated node 106-A connects over WIFI to a mobile terminal 104-A (hereinafter in the singular referred to as mobile terminal 104-A) when they are in close proximity to each other, to exchange messages based on a routing algorithm. The geographically separated node includes a client device and WIFI communication capability (i.e. 802.11 b/g). As mentioned, a geographically separated node is shared within a local community of users and supports user based authentication, enabling each individual end user to securely and privately access his/her subscribed service or application using this node.

In the messaging application, the client devices are used for composing, creating, sending, receiving and consuming (e.g., reading and printing messages) multimedia messages and data, and billing. In addition the client devices could also include other accessories like a printer—for printing out text/picture based messages/files, a biometric based authentication system for end user authentication, and the like. The messages, once delivered to the geographically separated node 106-A, are available within the geographically separated node 106-A until the user 114-A deletes the messages. The basic geographically separated node 106-A can be optionally equipped with a web camera, and a headset with microphone and speakers. Other accessories may be supported as well.

A mobile terminal 104-A provides a store and forward information transfer conduit. The mobile terminal 104-A could be hand-carried or installed on a physical transport system like a bus or a bicycle, as mentioned previously, and is used for storing and carrying information in the described network. Mobile terminal 104-A can communicate with a geographically separated nodes 104-A, with other mobile terminals, for example, 104-B and 104-B and the dispatch center 102 using cellular (GPRS) 118. At the beginning of each trip a mobile terminal 104-A is provisioned over the air with the transport route of the vehicle carrying it, the routing algorithm uses this route information to decide whether the mobile terminal 104-A should hold on to a message or send it to the dispatch Center 102 when it comes into cellular (GPRS) coverage.

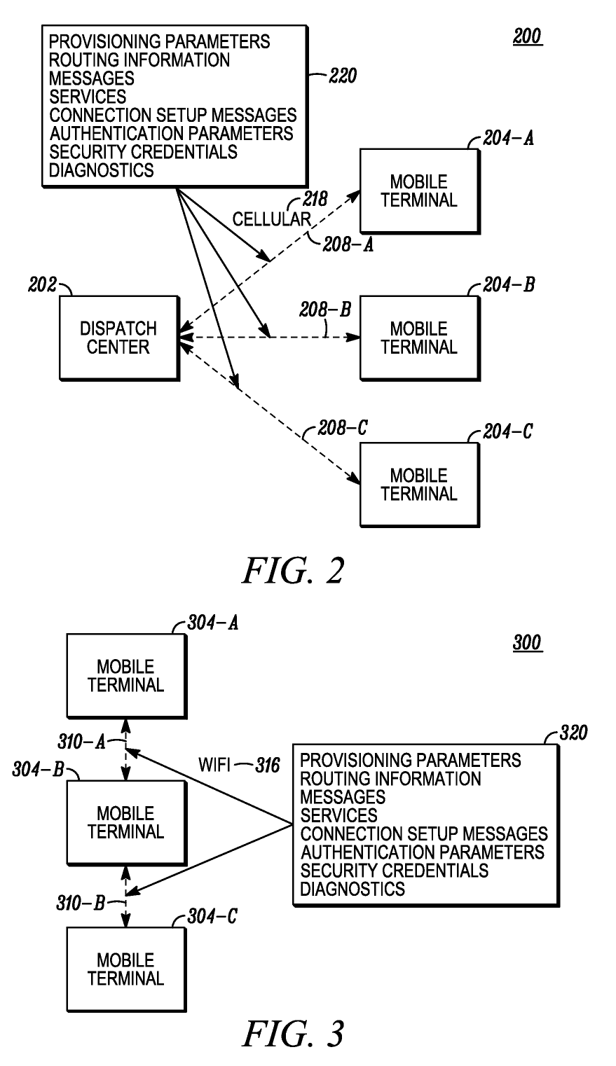

FIG. 2 is a block diagram of a system for enabling communication over a wireless intermittently connected network 200 in accordance with some embodiments. In one embodiment, the system controls message flows between the dispatch center 202, the mobile terminals 204-A, 204-B and 204-C. The proximity of a mobile terminal 204-A is detected by another mobile terminal 204-B, and a communication connection is formed between the mobile terminals. Messaging between the mobile terminals 204-A, 204-B and 204-C is described in detail below.

The various communications (i.e.message flows) in FIG. 2 are depicted by dotted lines that can be, for example, over a cellular network 218. For example, between the dispatch center 202 and the mobile terminals 204-A, 204-B and 204-C messages 208-A, 208-B and 208-C can flow. The system 200 controls the messages for the transfer of information in such a manner as to improve the reliability of Internet-based communications in the intermittently connected network. The information is at least in part based upon the various communications managed by the dispatch center 202 and communicated to at least one mobile terminal 204-A by at least one dispatch center 202. The messages 220 further include one or more of authentication parameters, security credentials, provisioning parameters, routing information, connection setup messages, services, messages, and diagnostics.

FIG. 3 is a block diagram of a system for enabling communication over a wireless intermittently connected network 300 in accordance with some embodiments. In one embodiment, the disclosed system controls message flows depicted by dotted line 310-A and 310-B between the mobile terminals 304-A, 304-B and 304-C that may be over, for example, WIFI 316. The disclosed system 300 controls the messages for the transfer of information so that Internet-based communications have more reliability in the discussed intermittently connected network. The information is at least in part based upon the various communications managed by the dispatch center 302 and communicated between a plurality of mobile terminals 304-A, 304-B and 304-C. The messages 320 further include one or more of authentication parameters, security credentials, provisioning parameters, routing information, connection setup messages, services, messages, and diagnostics.

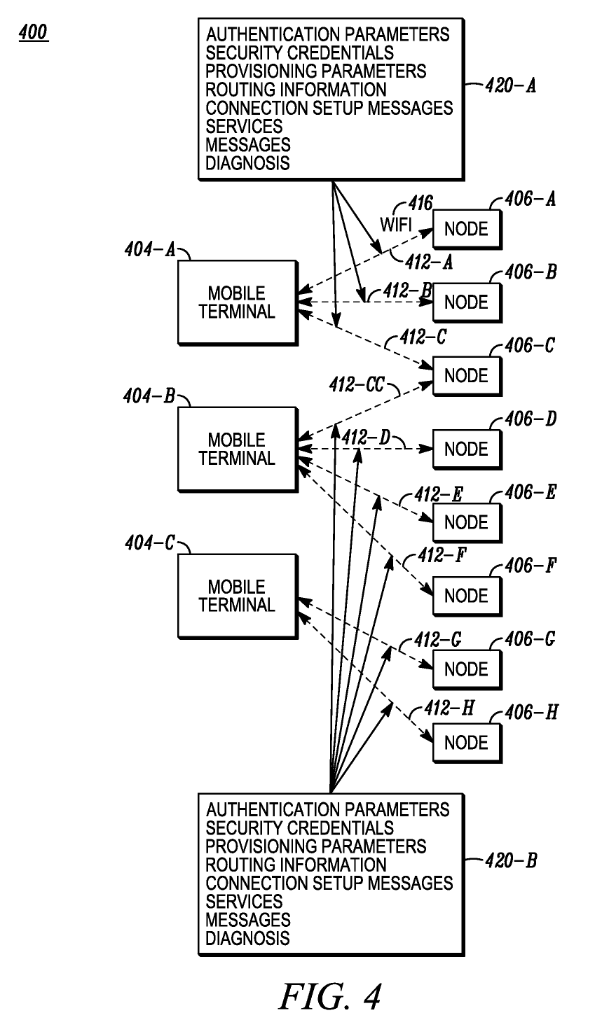

FIG. 4 is a block diagram of a system for enabling communication over a wireless intermittently connected network 400 in accordance with some embodiments. In one embodiment, the system controls message flows depicted by dotted lines 412-A, 412-B, 412-C, 412-CC, 412-D, 412-E, 412-F, 412-G and 412-H that may be over, for example, WIFI 416 between mobile terminals 404-A, 404-B and 404-C and geographically separated nodes 406-A, 406-B, 406-C, 406-D, 406-E, 406-F, 406-G and 406-H. The proximity of a mobile terminal is detected by a geographically separated node, and a communication connection between the mobile terminal and a geographically separated node is established. Messaging between them is described in detail below.

The disclosed system 400 controls the messages for the transfer of information so that Internet-based communications can have more reliability in the discussed intermittently connected network. The information is at least in part based upon the various communications managed by the dispatch center 102 (see FIG. 1) and communicated to and from a plurality of mobile terminals 404-A, 404-B and 404-C. The messages 420-A and 420-B further include one or more of authentication parameters, security credentials, provisioning parameters, routing information, connection setup messages, services, messages, and diagnostics.

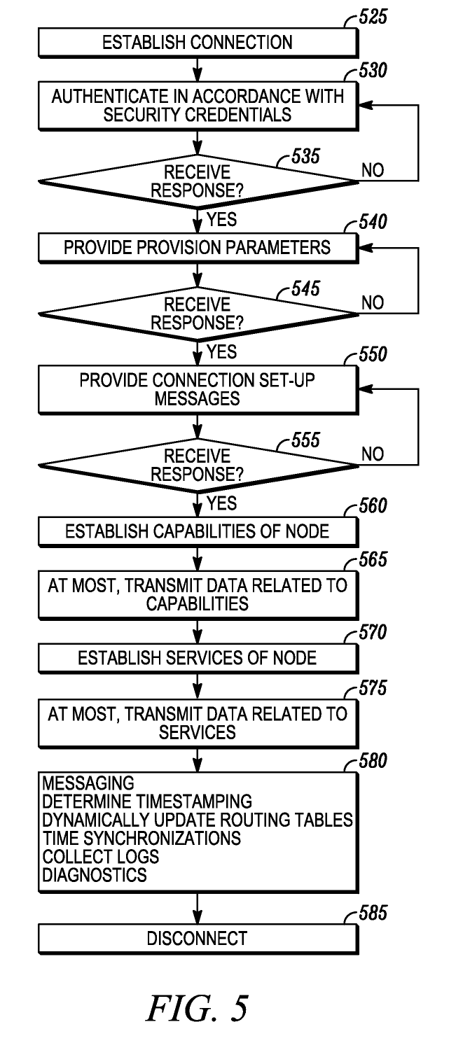

FIG. 5 is a flowchart illustrating one example of a method by which a mobile terminal of the system processes messages between the mobile terminal and a geographically separated node for the transfer of information to a geographically separated node in accordance with some embodiments as illustrated in FIG. 4. As illustrated by FIG. 5, the described connections for processing messages are setup on an as-needed basis. The messages for processing include one or more of authentication parameters, security credentials, provisioning parameters, routing information, connection setup messages, services, messages, and diagnostics (see 420-A and 420-B between mobile terminals 404-A, 404-B and 404-C and geographically separated nodes 406-A, 406-B, 406-C, 406-D, 406-E, 406-F, 406-G and 406-H of FIG. 4).

It is appreciated by those of ordinary skill in the art that control of messages, in particular routing information, can occur at the dispatch center 102 (see FIG. 1), one or more mobile terminals 104-A and one or more geographically separated nodes 106-A. In particular, the dispatch center 102 issues routing tables to a mobile terminal 104-A through which a message delivery route gets chartered. Under local conditions between a mobile terminal 104-A and a geographically separated node 106-A, such as if a memory is full, or if there is a history of messages having been previously delivered, a mobile terminal 104-A can decide locally the route for a message. However, the overriding control is derived from the routing tables that have been configured by dispatch center 102.

A mobile terminal 404-A (see FIG. 4) communicates with a geographically separated node 406-A in any suitable wireless manner such as by WIFI communications. Upon the establishment of a connection 525 between a mobile terminal 404-A and a geographically separated node 406-A, a message relating to authentication and security credentials 530 is transmitted to the geographically separated node by the mobile terminal. Until the message relating to authentication and security credentials 535 is acknowledged, no other messages are forwarded to the geographically separated node 406-A by the mobile terminal 404-A.

While discussed with reference to a transaction between a mobile terminal 404-A and a geographically separated node 406-A, in other embodiments, all or some of the system entities initially identify and authenticate themselves with the peer entity it encounters before any other transactions. Peer entities may communicate in the manner described with reference to FIGS. 1 2, 3 and 4. Peer entities are members of a peer set and provide an authentication protocol, that is, the corroboration that a peer entity is part of an association of peers that is the one claimed. Similarly, system entities are members of a system set that can provide an authentication protocol. Peer entities and system entities can use the step 530 to exchange, for example, identifiers, private/public keys and addresses.

In one embodiment, the mobile terminal 404-A acts as a client when establishing a communication connection with a geographically separated node 406-A and with the dispatch center 102 (see FIG. 1). There can be two or more stages of authentication. The first stage of authentication is required when connection is established at the physical media level (e.g., 802.11b/g and GPRS). The second stage of authentication is the system authentication, which occurs during setting up a connection with the system element by the application. For example, authentication at a geographically separated node includes the geographically separated node access point (AP) service set identifier (SSID) and Wired Equivalent Privacy (WEP) keys are used for 802.11b/g authentication and wireless data encryption. In a second step the mobile terminal identification (ID) and the system key are used for system authentication. In another embodiment, for example the authentication at the dispatch center 102, the first step includes the mobile terminal Integrated Services Digital Network (ISDN) number is used for GPRS authentication and wireless data encryption. In a second step the mobile terminal ID and the system key are used for system authentication.

The credentials of a mobile terminal, in one embodiment, are a fifteen (15) byte number uniquely identifying the mobile terminal within the system. Both the dispatch center and geographically separated node are provisioned with all mobile terminals identifications (IDs) in the system, and require this value for mobile terminal identification prior to authentication. An example of this value could be a mobile terminal Mobile Station (MS)-ISDN number. In yet another embodiment, a single byte key/password is used by both the dispatch center and geographically separated nodes to authenticate a mobile terminal in the system. This key value can be encrypted and stored in a secure manner in each node of the system.

Upon successful verification of the identity by the peer entity, a response is sent to the requestor. Secure communication connection is used for this transaction. By proceeding with a next step 540 in the operation only after receipt 535 of a response to transmitting of security credentials 530 indicating a successful verification by the peer entity, constraints on the bandwidth, processing power and storage capabilities of entities of the intermittently connected networks can be minimized. That is, if a sufficient response 535 is not received, the requester transmits another message relating to authentication and security credentials, repeating step 530.

Upon successful verification of the identity by the peer entity, that is, a positive response 535 has been sent to the requester, the mobile terminal 404-A then transmits a message relating to provision parameters 540. Until the message relating to provision parameters 540 is acknowledged by a positive response 545, another type of message is not forwarded to the geographically separated node 406-A by the mobile terminal 404-A.

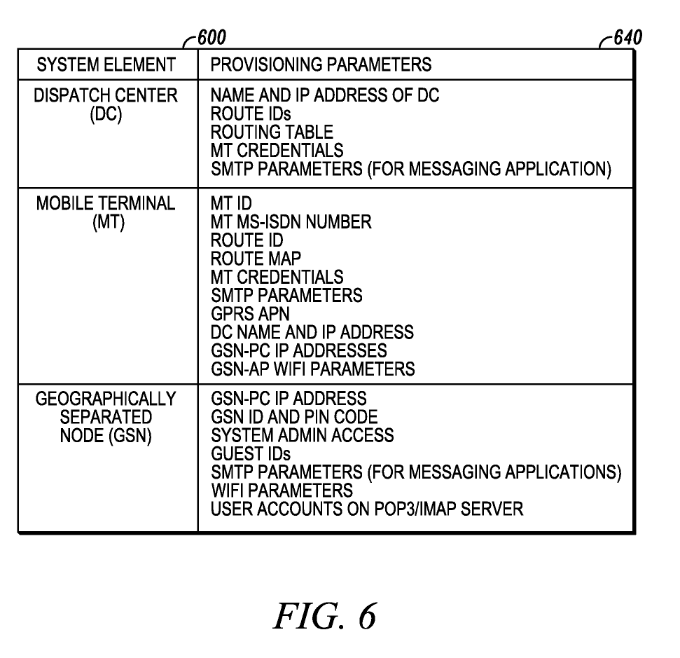

Provision parameters generally configure system entities such as mobile terminals and geographically separated nodes to make them operational. Provisioning can be categorized into setup related and routing related provisioning. The typical parameters that may be provisioned by the disclosed system are, for example, routing tables, addition/deletion of geographically separated nodes, and addition/deletion of mobile terminals. Due to the disconnected nature of the network, provisioning parameters are transferred only during encounters between system entities. The transfer of provisions can contain a timestamp to ensure that parameters are transferred only if they are more recent than the current parameters. A successful provisioning transaction would be completed, for example, on acknowledgement by the “being-provisioned” system entity. In one embodiment, this transaction will be initiated only after successful identification and authentication between the system entities. In order to ensure that the mail exchange messages are routed based on latest provisioning parameters, provisioning steps are initiated before any mail exchange. Briefly turning to FIG. 6, a chart of examples of various provisioning parameters 640 in accordance with example system elements 600 is illustrated.

It is understood that the flowchart of FIG. 5 is an example of the manner in which the disclosed system controls messaging between two or more system entities. Other steps may be included and/or deleted. For example a command step can be provided wherein specific commands like mobile terminal-CLEAR, and mobile terminal-RESET can be sent to the system entities. The receiving entity acts faithfully on such commands and acknowledge the successful completion of the same. Only such commands whose functionality is fully known across the network only is used in this step. For example, on receipt of mobile terminal-CLEAR, a geographically separated node flushes all its message queues and starts afresh with current routing parameters. Similarly, mobile terminal-RESET will flush all its message queues and resort parameters like routing tables to default values. Since, these commands can lead to significant changes in the network, it will be initiated only from dispatch center 102 (see FIG. 1) and the transactions are securely transferred. In this example, such a step takes precedence over provisioning 565 and is performed immediately after successful identification and authentication 564.

Returning to FIG. 5, next a mobile terminal provides connection set up messages after the provision parameters have been provided 540 and a positive response is received 545. In one embodiment, the disclosed system provides control for enabling opportunistic connections between disconnected nodes using store-and-forward mechanism. A control protocol is provided for the system for setting up a secure system network and subscribers on this network, running different applications and services on the network, intelligent routing of messages, scaling the network dynamically to support change of network topologies as well as additional nodes and operations, diagnosing the network for trouble shooting, as well as securing the network against threats. In one example, a mobile terminal 404-A (see FIG. 4) provides to a geographically separated node 406-A connection set-up messages 550 and if a positive response is received 555, the next step of establishing capabilities 560 of the geographically separated node 406-A is commenced.

In the process of FIG. 5, between a mobile terminal and a geographically separated node, service capability negotiations are enabled based on node capacity, such as memory size, processing power, bandwidth limitation. Asynchronous methods can be used to also determine the network state at any time instance, and reported state of any geographically separated node in terms of its available memory, processing capacity as well as current bandwidth conditions. The results from invoking this step could be used to determine service capabilities of the network. A step of capability negotiation 560 is beneficial considering the fact that all the system entities do not have the same capability. There are mobile terminals of very limited capability, and geographically separated nodes which are personal computers (PCs) with larger capability. In the described embodiment, that, at most, the data is transferred 565 between the entities is related to their respective capacities.

As mentioned previously, the difference in the computing power of a dispatch center 102 (see FIG. 1), a mobile terminal 104 and a geographically separated node 106, may be substantial. Moreover, different mobile terminals as well as different geographically separated nodes can be of substantially different types of machines. Constraints on the bandwidth, processing power and storage capabilities of the components of intermittently connected networks can make routine Internet-based communications slow and unreliable. The system described herein controls the messages for the transfer of information, in particular depending upon capacities, and as will be discussed, the services rendered, so that Internet-based communications have more reliability in the discussed intermittently connected network. Similarly the process depicted in FIG. 5, depicts that services of the geographically separated node 406-A (see FIG. 4) are established 570. In the described embodiment, that, at most, the data is transferred 575 between the entities is related to the defined services.

Continuing with FIG. 5, the operation includes a number of processes 580 that, in one embodiment, take place between the mobile terminal and the geographically separated node. For example, messaging, timestamping, dynamically updating routing tables, time synchronizations, collection of time logs and diagnostics are examples of processes 580.

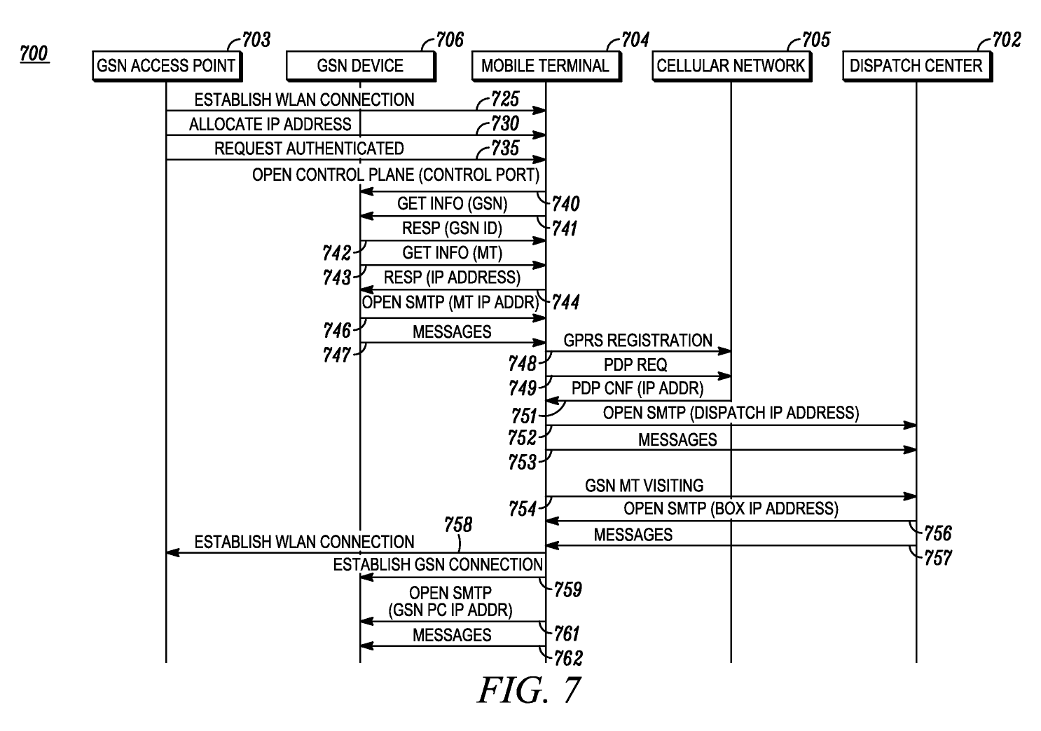

FIG. 7 is a signal diagram illustrating an example outgoing call flow for messaging 700 from a geographically separated node. A mobile terminal 704 and a geographically separated node (GSN device) 706, for example, communicate via WIFI. Accordingly, a geographically separated node access point 703 configured for WIFI communication for a geographically separated node 706 can establish with mobile terminal 704 a wireless local area network (WLAN) connection 725. An Internet Protocol (IP) address is allocated 730 and the request of the geographically separated node access point 703 is authenticated 735.

The mobile terminal 704 can create a control protocol connection 740 to the geographically separated node device 706. A control protocol connection 740 between the mobile terminal 704 and the geographically separated node device 706 creates or opens a control plane connection, also known as a control port. In routing, the control plane is the part of a router architecture that is concerned with the information in a routing table that defines what to do with incoming packets. A routing table contains a list of destination addresses. The mobile terminal 704 queries 741 the geographically separated node device 706 for credentials and then credentials such as the geographically separated node device 706 identification (GSN Id) are exchanged 742 with the mobile terminal 704. In turn, the geographically separated node device 706 queries 743 the mobile terminal 704 for its IP address which in response 744 is used to establish a Simple Mail Transfer Protocol (SMTP) connection by the geographically separated node device 706. An SMTP connection is established 746 by geographically separated node device 706 with the mobile terminal 704. Messages that originate from the geographically separated node device 706 can then be delivered 747 to the mobile terminal 704 for further routing. The messages that may be delivered include, for example, those listed 580 (see FIG. 5) including email messaging, determining timestamping, dynamically updating routing tables, time synchronization, collection of logs and diagnostics. Further steps including closing the SMTP, control plane and WIFI connections can be provided upon message transfer completion.

The mobile terminal 704 can then move away from the geographically separated node device 706. The mobile terminal 704 can sense an active cellular GPRS connection 705 and initiate 748 GPRS registration. The mobile terminal 704 may then issue a packet data protocol (PDP) request 749 to establish a data connection with the GPRS network 705. The GPRS network 705 can respond 751 back a successful response to the data connection request (PDP confirmation). This response contains an IP address (IP addr) allocated by the GPRS network 705 for the mobile terminal 704 so that the mobile terminal 704 is connected on the GPRS network. By the establishment of a control plane connection with the dispatch center 702, the mobile terminal 704 can send credentials to the dispatch center 702. After validations, the mobile terminal 704 can send an IP address allocated by the GPRS network 705 to the dispatch center 702.

The mobile terminal 704 over the control plane can indicate 754 to the dispatch center 702 which geographically separated nodes 106-A, 106-B, 106-C, 106-D, 106-E, 106-F, 106-G and 106-H (see FIG. 1) it will be visiting. The dispatch center 702 may have messages to be delivered to geographically separated node devices 106-A, 106-B, 106-C, 106-D, 106-E, 106-F, 106-G and 106-H that the mobile terminal 704 is about to visit. Hence, the dispatch center 702 opens 756 a SMTP connection with the mobile terminal 704 and transfers 757 those messages to the mobile terminal 704. After transferring messages to the mobile terminal 704, the dispatch center can close the SMTP connection. Furthermore, the mobile terminal 704 can close the control plane. Also, the mobile terminal 704 can close the PDP connection request sent to the GPRS network 705.

The mobile terminal 704 can encounter another geographically separated node device, possibly geographically separated node 106-A, 106-B, 106-C, 106-D, 106-E, 106-F, 106-G and 106-H (see FIG. 1). For simplicity purposes in the signal diagram of FIG. 7, a different geographically separated node device is depicted by geographically separated node device 706. In establishing a WLAN connection 758 and therefore establishing a connection with geographically separated node device 706, the mobile terminal 704 and the different GSN device 706 recreates 758 the steps 725, 730, 735, 740, 741, 742, 743, 744, 746, and 747. The mobile terminal 704 can open 761 a SMTP connection with the geographically separated node device 706 to transfer messages. The mobile terminal 704 can then transfer 762 messages to the geographically separated node device 706. The mobile terminal 704 can close the SMTP connection on completion of the transfer.

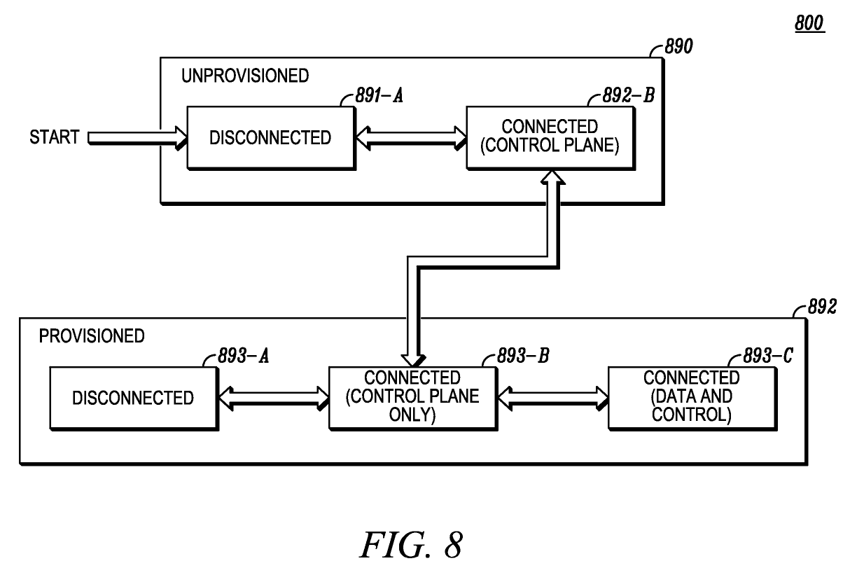

FIG. 8 illustrates examples of different states 800 of a mobile terminal 104 (see FIG. 1). The mobile terminal manages connections with a dispatch center 102, geographically separated nodes, such as geographically separated node 106-A, other mobile terminals, and other elements and/or entities of the disclosed intermittently connected network. In an unprovisioned state 890 a mobile terminal 104 has not been provisioned for any routes, or it has completed all routes that is supposed to and there are no more transactions to upload to a dispatch center 102. Two main states of a mobile terminal 104 in an unprovisioned state 890 are disconnected 891-A or connected 891-B. As discussed above, a mobile terminal 104 may be provisioned by the dispatch center 102. Once provisioned 892, the mobile terminal 104 may be in a disconnected state 893-A, a connected state 893-B where it is opening the control plane (see step 740 of FIG. 7) or a connected state 893-C wherein it processes data and controls (see steps 741, 742, 743, 744, 746, 747 of FIG. 7).

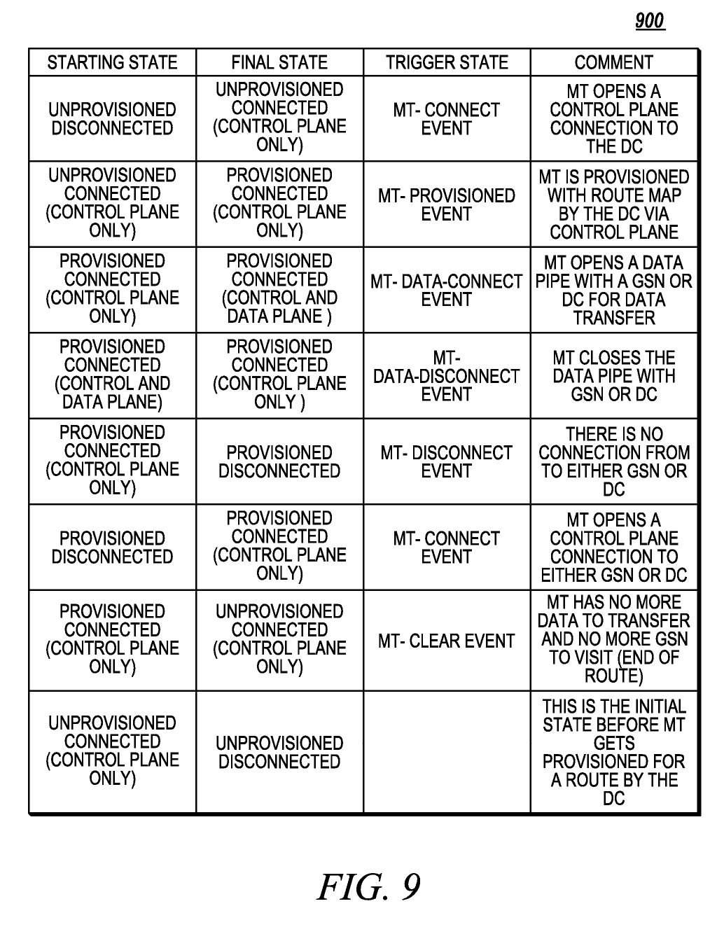

The table of FIG. 9 is an example transition state table 900. For the data plane established between the mobile terminal 104-A (see FIG. 1) and the geographically separated node 106-A via a WIFI connection 116 and that between the mobile terminal 104-A and the dispatch center 102 via a GPRS network 118, the rules set forth in FIG. 9 apply. A data plane determines packet behavior such as packet forwarding, packet differentiation, such as buffering and link scheduling. The table of FIG. 9 depicts mobile terminal events which are described as follows:

Mobile terminal connect event includes:
a. Event generated when Mobile terminal in DISCONNECTED state.
b. In PROVISIONED state, Mobile terminal establishes a Control Plane connection to either DISPATCH CENTER or to Geographically separated node.
c. In UNPROVISIONED state, Mobile terminal establishes a Control Plane connection only to DISPATCH CENTER.
d. Mobile terminal transitions to CONNECTED (Control Plane only) state.
   Mobile terminal-PROVISIONED event:
a. Event generated on the Mobile terminal either based on static configuration or based on an OTA update from the DISPATCH CENTER.
b. Event generated when Mobile terminal is in UNPROVISIONED-CONNECTED (Control Plane only) state. Mobile terminal must be connected to DISPATCH CENTER.
c. Mobile terminal gets provisioned for a new route by DISPATCH CENTER.
   Mobile terminal DATA-CONNECT event:
a. Event generated when Mobile terminal in CONNECTED (Control Plane only) state.
b. Mobile terminal opens a data pipe with the Geographically separated node or DISPATCH CENTER for data transfer.
c. Mobile terminal transitions to CONNECTED (Data and Control Plane) state.
   Mobile terminal DATA-DISCONNECT event:
a. Event generated when Mobile terminal in CONNECTED (Data and Control Plane) state.
b. Mobile terminal closes the data pipe with the Geographically separated node or DISPATCH CENTER.
c. Mobile terminal transitions to CONNECTED (Control Plane only) state.
   Mobile terminal DISCONNECT event:
a. Event generated when Mobile terminal in CONNECTED (Control Plane only) state.
b. Mobile terminal closes all connections.
c. Mobile terminal transitions to DISCONNECTED state.
   Mobile terminal_CLEAR event:
a. Event generated when Mobile terminal is connected to DISPATCH CENTER in PROVISIONED state.
b. Flushes all remaining messages to be sent from Mobile terminal to DISPATCH CENTER
c. Makes the routing table inactive.
d. Transitions to CONNECTED-UNPROVISIONED state.
   The Routing Table becomes inactive under the following conditions:
1. No more geographically separated nodes to visit and no messages to transfer to either DISPATCH CENTER or geographically separated nodes.
2. Timer expired for routing table.
   Mobile terminal-RESET event
a. Event generated when Mobile terminal is connected to DISPATCH CENTER in either UNPROVISIONED or PROVISIONED state.
b. Makes the routing table inactive.
c. Closes all connections.
d. Transitions to DISCONNECTED state.
   Mobile terminal-POWER OFF event
   After a non-scheduled Power off, Mobile terminal shall be able to recover the following information from persistent storage:
a. Last stable state before Power Off event.
b. State of its route map, i.e., the Geographically separated nodes it was supposed to visit when Power off event occurred.

A mobile terminal, in one embodiment, is able to take corrective action upon connection establishment with an out-of-order geographically separated node after restoration of power. This may occur if the bus on which the mobile terminal is hosted has already passed one or more geographically separated nodes on its route before power is restored.

In one embodiment of the disconnected state, the decision to accept new connection would be decided on the following parameters. In one example, messages to be delivered to the geographically separated node or dispatch center from a mobile terminal are based on the routing information provisioned at the mobile terminal. In another example, access network availability is provided to establish the 802.11b/g connection or/and GPRS connection for receiving messages. In still another example, a mobile terminal is of a state to receive or send messages. For example, if the total memory available in the mobile terminal for new messages is zero, then it will not establish any session with the access points to receive messages provided it has no messages to transfer to the geographically separated node or dispatch center in its vicinity. In another example, a geographically separated node device capability may allow it to support more than one connection at a time in accordance with entities or resources that characterize this parameter. In still another example of priority of the connection, if the system is modeled by providing higher priority for WIFI connection and the device does not allow simultaneous connections, any new GPRS connection request would not be allowed. Similarly, if there is a GPRS connection in CONNECTED state and a high priority WIFI connection request arrives, then GPRS transfers would be gracefully torn down and WIFI connection established. Generally, any status change to any of the above parameters would lead to re-evaluation of the connection status.

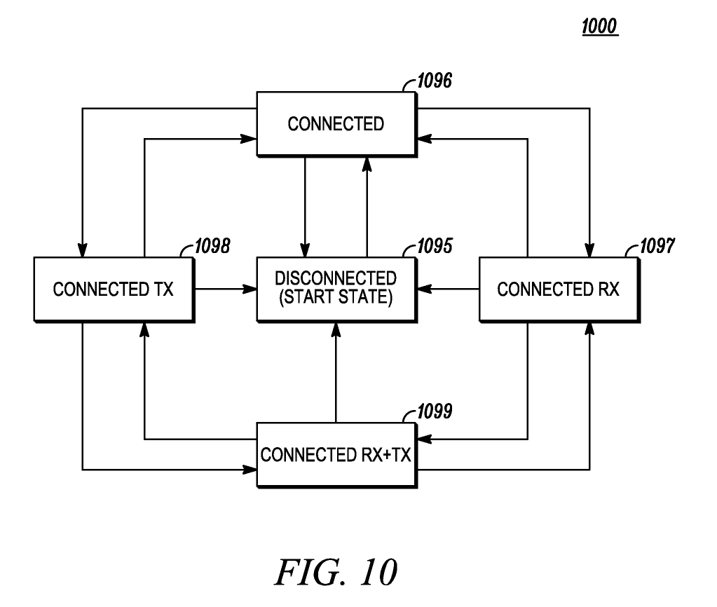

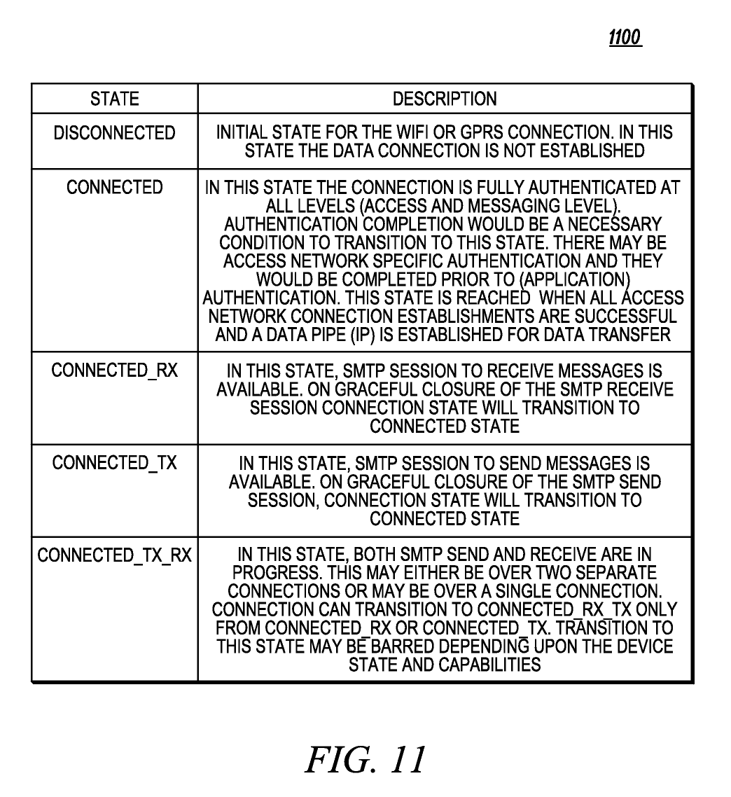

FIG. 10 depicts an embodiment of different states 1000 for different data connections in the system and is independent of the actual type of physical access media used. The terms of FIG. 10 include receive/transmit (RX/TX) In particular, in the initial state 1095 for the WIFI 116 (see FIG. 1) or the cellular connection 118, there is no connection. In a connected state 1096, the connection, either the WIFI 116 or the cellular connection 118, is fully authenticated. In the connected RX state 1097, the SMTP session to receive messages is available. In the connected TX state 1098, the SMTP sessions is available to send messages. In the connected RX+TX state 1099, both SMTP send and receive are in progress. The table of FIG. 11 is a transition state table 1100 and more fully describes states of the flowchart of FIG. 10.

Due to sporadic nature of connectivity that characterizes a disconnected network like the described system, services are checked periodically for availability of connections. This is done periodically and since the mobile terminal has limited processing power and memory. A light weight protocol to setup and monitor connections in enabled in the system. Services over such a disconnected network can be very varied. Processes such as messaging, provisioning is leveraging such an opportunistic networking. A control protocol that is generic and independent of services establishes applications and services layer sessions is described. As the described network is not always connected, message control to connect Simple Mail Transfer Protocol (SMTP) relays whenever possible is described.

As described above, in one embodiment, key characteristics include that the interaction model is a client server model. The servers are run on the geographically separated node and the dispatch center systems and clients would run on the mobile terminal devices. Internet Protocol (IP) ports for listening and connecting would be configurable and provisioned by the network operator in mobile terminals, geographically separated nodes and dispatch center. On successful connection establishment between a client and a server, the client will identify itself to the server. The server function is assumed to be hosted on the trusted entity in the network system (dispatch center or a geographically separated node). Authentication parameters are supplied by client and validated by the server. On successful authentication, the client and server will be able to initiate transactions between them. Client initiated transactions and server initiated transactions go on separate network connections. The responses to transaction requests will be sent over the same connection over which transaction request was received. Both client and server will initiate new transaction only after the completion of the previous one, that is, they will initiate a new transaction only after response to the previous transaction request is completely received. There may be multiple transaction responses. All transactions and transaction responses will be tagged by a transaction Id (Tid). There maybe multiple transaction responses to a transaction request. Hence, each transaction will be closed explicitly by the responding side, based on which the receiving side will mark the transaction to be complete. In particular initially identified transaction service primitives include:

Identifier request service (IDX-REQ) will be used to exchange system element identifiers (such as like mobile terminal Id, geographically separated node Id, and the like) and IP addresses. Identifier request response (IDX RESP) will contain the response for the request.

Provisioning parameters request (PROV-REQ) will contain response for the request and the provisioning parameters.

Command Request (CMD-REQ) are commands that will contain events like mobile terminal-CLEAR, mobile terminal-RESET that will change the state of the mobile terminal 104 (see FIG. 1). Any command directives will be sent using this service. CMD_RESP will contain the status indicating the successful or unsuccessful completion of the command execution

Diagnostic Request (DIAG-REQ) contains the diagnostic parameters needed to trace a transaction within the system.

Asynchronous Response (SYNC-RESP) includes asynchronous reports or responses from system entities. This may contain alarms or periodic updates of status, and the like. There will be no response to this from the receiving side.

In one embodiment, transactions are encoded and hence will be a binary protocol. Each transaction request or response will necessarily have to contain <service id>, <service type>, <length of message> <payload>. Payload will be different for each of the services. Transaction responses contain fields indicating any errors in the transaction request. Error recovery and strategies are defined. Closure of the control plane connection can be started either by a client or a server at any point of time. A transaction can be broken before completion of a request/response session and the application will have the logic to recover from such transaction adjournments.

Referring again to FIG. 5, there are a number of processes 573 that in one embodiment take place between the mobile terminal and the geographically separated node and/or other entities as described above. For example, messaging, timestamping, dynamically updating routing tables, time synchronizations, collection of time logs and diagnostics are examples of processes 580. For example, asynchronous messages include unsolicited status messages can be sent by network elements using this method. Typical parameters are alarms, status, and the like. In one embodiment, every entity is expected to transmit these messages to the network elements that it encounters. All messages will be timestamped at the originating network element and only the latest status is updated. In order to avoid flooding of network with these alarms, the dispatch center can choose to remove these messages at any point of time.

Route paths and Routing table include updates intended to various nodes (mobile terminals and geographically separated nodes) in the network. A mobile terminal and geographically separated nodes are provisioned with Route Maps (routing table for the messages to follow) by the dispatch center at the beginning of each run. In one embodiment, the routing table updates are provided by the dispatch center and/or a mobile terminal. The provisioning method is invoked to dynamically install and update the routing paths and tables on mobile terminals and geographically separated nodes.

Information about services that are required to consume specific content that will be exchanged between the geographically separated node and the mobile terminal, are communicated between entities of the system. In the event that one of the nodes does not have the requisite service the content will not be exchanged. The geographically separated node provides information specific to services that it hosts to ensure that only content relevant to services that it hosts are downloaded. In the case of mobile terminals, there could be occasions when some mobile terminals are used to access specific services, such information is helpful to ensure that the mobile terminal does not carry unnecessary data. In one embodiment, the control of messages is used to carry time sync messages to ensure that all nodes in the system maintain time synchronization.

Diagnostics information and logs collected from various node includes trace messages, heart-beat of network elements, and state of each network element. In one embodiment, each request method will contain the information that needs to be traced and response will contain the corresponding data. Any network element can invoke the diagnostics process. Diagnostics can be scheduled anytime after the initial identification and authentication step of the network operations. Moreover, the system can include messages that monitor state of the connections, and state of nodes (defined by memory state) and make routing decisions of messages. Asynchronous methods can be used to also determine the network connectivity state at any time instance, reported state of any system node. Results from invoking this method could be used to modify routing decisions on the mobile terminals in a dynamic fashion.

Another embodiment includes bootstrap provisioning of each node in the network which includes the control plane access ports, protocols and authentication parameters (to become part of the trusted network). Bootstrap provisioning method is used to provision new nodes with boot-up parameters like identifiers, and authentication keys. These may either be physically carried and used to provision the entity or may be transmitted. The “being-provisioned” entity may listen in pre-defined ports for becoming provisioned.

In another embodiment, the system includes device management of each node in the network where dynamic device management updates on the nodes, which contains new authentication keys, route maps, connection wake-ups and assigns identities to each node in the network based on a naming convention chosen by the operator. The system schedules the services using a service control function to determine service instantiations based on available networks, service provisioning and service life cycle (start, pause, stop). Moreover, diagnostics and system information collects system level diagnostics for network management and broadcast of system level information. In general, actions are taken in securing against rogue nodes from joining the network.

Referring again to FIG. 5, the disconnection of entities of the intermittently connected network may take place in a suitable manner. It is understood that the flowchart of FIG. 5 is an example of the manner in which the disclosed system controls messaging between two or more system entities. Other steps may be included and/or deleted.

The above-described system includes that apart from the primary function of dispatching services, the dispatch center provides for provisioning of all geographically separated nodes and mobile terminals in the system and all of its subscribers or end users, as well as authentication of the mobile terminals, and also provides billing and services portal for geographically separated nodes and mobile terminal operators. The data would then be transferred to respective mobile terminals based on protocol request. Mobile terminals would register with the dispatch center when they come into cellular coverage and specify the address of the geographically separated nodes that they would be serving. The dispatch center would also service download requests from mobile terminals for specific geographically separated nodes within the intermittently connected network. In one embodiment, a mobile terminal device is a dual mode device, with a WIFI access to synchronize with village geographically separated nodes as also with other mobile terminal devices and a data cellular access to synchronize with the dispatch center in the cellular network.

Services offered over such disconnected networks provide special considerations because services could be varied. For example due to the above discussed constraints of an intermittently connected network, messaging, provisioning, authentication, and the like, that is, different Applications/Services should be optimally started and executed only if all desired connections are available for receive/transmit (RX/TX). Savings on power, million instructions per second (mips), cost, and the like may result. Knowledge and awareness of disconnectedness to the network provides an ability to perform at optimal levels since nodes delivering such services are not always connected. The nodes are not connected either because they are outside the network infrastructure, or it is unviable to be always connected for economic reasons. In one embodiment, the nodes are periodically checked for availability of connections. This periodic check should not become chatty or expensive due to constraints. The system for message control leverages the physical transport network to provide an asynchronous communication network.

A node could become connected to different entities having different capabilities. The mobile terminals (message carrier in the network) have limited processing power and memory constraints. The disclosed system for controlling messaging includes processes for connection setup between endpoints, authentication support, capability matching to ensure relevant applications are notified at both ends, support for distribution and collection of control information for the network including provisioning, synchronization, route information, support for different network connection types and applications, asynchronous connectivity irrespective of type of services and applications, leveraging the above networking assumptions (local, wide area, transport augmented), overlays over existing messaging control protocols and scalability in terms of network nodes.

As discussed, the type of information exchanged in the controlled messages includes route paths and routing table updates intended to various nodes in the network, provisioning information for the geographically separated nodes, mobile terminals and applications running on this network, service information including time synchronizations, diagnostics information and logs collected from various node enable service capability negotiations based on capability of the nodes (for example, memory, processing, and bandwidth), the monitored state of the connections, nodes (for example, memory) decisions of routing messages based on those parameters, and authenticated security credentials of the nodes. Bootstrap provisioning of each node in the network includes the control plane access ports, protocols and authentication parameters to become part of the trusted network. Device management of each node in the network includes a dynamic device management updates on the nodes, which contains new authentication keys, route maps, connection wake-ups and assigns identities to each node in the network based on a naming convention chosen by the operator. Scheduling the services using a service control function is used to determine service instantiations based on available network, service provisioning and service life cycle (start, pause, stop). Diagnostics and system information collects system level diagnostics for network management and broadcast of system level information. Also the described system for enabling communication over a wireless intermittently connected network includes securing against rogue nodes from joining the network.

Since constraints on the bandwidth, processing power and storage capabilities of intermittently connected networks can make their execution unreliable, systems for controlling message flows that minimize the effects of the mentioned constraints are desirable. As intermittently connected networks become more available, bringing low-cost Internet-based communication services to rural areas, it would be beneficial if systems for enabling communication over a wireless intermittently connected network are independent of the services and/or applications. Moreover, it would be beneficial if the above-discussed constraints were minimized by controlling message flows in a manner that facilitates deployment of services and/or applications.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A system for enabling communication over a wireless intermittently connected network, the system comprising:
at least one dispatch center for managing various communications of the intermittently connected network;
a plurality of geographically separated nodes; and
at least one mobile terminal intermittently communicatively coupled to the at least one dispatch center;
wherein the at least one mobile terminal is configured to provide a communication network to the plurality of geographically separated nodes for the transfer of information among the plurality of geographically separated nodes, wherein the information is at least in part based upon the various communications managed and communicated to the at least one mobile terminal by the at least one dispatch center, and comprises one or more of authentication parameters, security credentials, provisioning parameters, routing information, connection setup messages, services, messages, and diagnostics.

2. The system of claim 1 wherein a mobile terminal is configured to transfer and receive of information related to authentication and security credentials prior to the transfer of information related to provisioning.

3. The system of claim 1 wherein a mobile terminal is configured to transfer and receive of information related to provisioning prior to the transfer of a message exchange.

4. The system of claim 1 wherein a mobile terminal is configured to transfer and receive information relating to routing information, and generate update routing information.

5. The system of claim 1, wherein network elements includes at least one of a dispatch center, a plurality mobile terminal and a plurality geographically separated node wherein the messages include diagnostics information and logs collected from one or more geographically separated nodes, wherein the diagnostic information includes one or more of trace messages, heart-beat of network elements, and state of each network element.

6. The system of claim 1, wherein the dispatch center operates as a messaging hop for Internet gateway to and from the geographically separated nodes.

7. The system of claim 1, wherein each of the plurality of mobile terminals:
communicates with the dispatch center using a first communication protocol; and
communicates with each of the plurality of geographically separated nodes using a second communication protocol.

8. A system for enabling communication over a wireless intermittently connected network, the system comprising:
at least one dispatch center for managing various communications of the intermittently connected network;
a plurality of geographically separated nodes; and
a plurality of mobile terminals intermittently communicatively coupled to each other and intermittently communicatively coupled to one or more of the plurality of geographically separated nodes,
wherein the plurality of mobile terminals are configured to communicate messages with each other, to provide a communication network to the plurality of geographically separated nodes for the transfer of information among the plurality of geographically separated nodes, wherein the information is at least in part based upon the various communications managed and communicated to at least one mobile terminal by the at least one dispatch center, and comprises one or more of authentication parameters, security credentials, provisioning parameters, routing information, connection setup messages, services, messages, and diagnostics.

9. The system of claim 8 wherein a mobile terminal is configured to transfer and receive of information related to authentication and security credentials prior to the transfer of information related to provisioning.

10. The system of claim 8 wherein a mobile terminal is configured to transfer and receive of information related to provisioning prior to the transfer of a message exchange.

11. The system of claim 8 wherein a mobile terminal is configured to transfer and receive information relating to routing information, and generate updated routing information.

12. The system of claim 1 wherein messages are transferred and received between mobile terminals.

13. The system of claim 12, wherein each message comprises a timestamp and at least one parameter, and further wherein the at least one parameter is transferred between a dispatch center and a mobile terminal when the timestamp of the message is subsequent in time to a timestamp of a corresponding stored parameter.

13. The system of claim 12, wherein the messages comprises one or more of route paths, routing table updates, provisioning information for the geographically separated nodes and the mobile terminals, provisioning information for one or more applications running on the intermittently connected network, service information including time synchronizations, and diagnostics information and logs collected from one or more of the geographically separated nodes.

14. The system of claim 8, wherein network elements includes at least one of a dispatch center, a plurality mobile terminal and a plurality geographically separated node wherein the messages include diagnostics information and logs collected from one or more geographically separated nodes, wherein the diagnostic information includes one or more of trace messages, heart-beat of network elements, and state of each network element.

15. The system of claim 8, wherein each of the plurality of mobile terminals:
communicates with the dispatch center using a first communication protocol; and
communicates with each of the plurality of geographically separated nodes using a second communication protocol.

16. A system for enabling communication over a wireless intermittently connected network, the system comprising:
at least one dispatch center for managing various communications of the intermittently connected network;
a plurality of geographically separated nodes; and
at least one mobile terminal intermittently communicatively coupled to one or more of the plurality of geographically separated nodes,
wherein the at least one mobile terminal is configured to provide a communication network to the plurality of geographically separated nodes for the transfer of information among the plurality of geographically separated nodes, wherein the information is at least in part based upon the various communications managed and communicated to the at least one mobile terminal by the at least one dispatch center, and comprises one or more of authentication parameters, security credentials, provisioning parameters, routing information, connection setup messages, services, messages, and diagnostics.

17. The system of claim 16 wherein a mobile terminal is configured to transfer and receive of information related to authentication and security credentials prior to the transfer of information related to provisioning.

18. The system of claim 16 wherein a mobile terminal is configured to transfer and receive of information related to provisioning prior to the transfer of a message exchange.

19. The system of claim 16 wherein a mobile terminal is configured to transfer and receive information relating to routing information, and generate update routing information.

20. The system of claim 16 wherein a mobile terminal is configured to transfer and receive information related to capabilities, and is configured to transfer, at most data based on determined capabilities.

21. The system of claim 16, wherein each of the geographically separated nodes includes one or more service capabilities, wherein the service capabilities include one or more of a capacity, memory size, processing power, and bandwidth limitation, and further wherein the messages comprises service capability negotiations for determining a network state.

22. The system of claim 16 wherein a mobile terminal is configured to transfer and receive information related to services, and is configured to transfer, at most data based on determined services.

23. The system of claim 16 wherein messages are transferred and received between a mobile terminal and a geographically separated node.

24. The system of claim 23, wherein each message comprises a timestamp and at least one parameter, and further wherein the at least one parameter is transferred between a geographically separated node and a mobile terminal when the timestamp of the message is subsequent in time to a timestamp of a corresponding stored parameter.

25. The system of claim 23, wherein the messages comprises one or more of route paths, routing table updates, provisioning information for the geographically separated nodes and the mobile terminals, provisioning information for one or more applications running on the intermittently connected network, service information including time synchronizations, and diagnostics information and logs collected from one or more of the geographically separated nodes.

26. The system of claim 23, wherein network elements includes at least one of a dispatch center, a plurality mobile terminal and a plurality geographically separated node wherein the messages include diagnostics information and logs collected from one or more geographically separated nodes, wherein the diagnostic information includes one or more of trace messages, heart-beat of network elements, and state of each network element.

27. The system of claim 16, wherein the dispatch center operates as a messaging hop for Internet gateway to and from the geographically separated nodes.

28. The system of claim 16, wherein each of the plurality of mobile terminals:
communicates with the mobile terminal using a first communication protocol; and
communicates with each of the plurality of geographically separated nodes using a second communication protocol.
